(19) United States
(12) Patent Application Publication
(10) Pub. No.: US 2003/0069981 A1
(43) Pub. Date: Apr. 10, 2003

(54) IP hopping for secure data transfer

(75) Inventor: Karen I. Trovato, Putnam Valley, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/973,311

(22) Filed: Oct. 9, 2001

(51) Int. Cl. G06F 15/16

(52) U.S. Cl. 709/228; 713/201

(57) ABSTRACT

The IP address for requesting data within a data set is changed during the transfer of the data set. This changing address may include the IP addresses of different ports on a server, or may indicate the IP addresses of different servers. The pattern of changes of the IP address is known to both the client and the server(s), and preferably secret from others. Without knowing the pattern of changes of IP addresses, it will be difficult for an eavesdropper to intercept the data set. To further enhance the security of this approach, the server system is configured to expect subsequent requests at the changed IP address. If the subsequent requests do not arrive within a threshold time period, the server system is configured to terminate further access to the data set by the requestor.

### BACKGROUND OF THE INVENTION

1. Field of the Invention

This invention relates to the field of communications, and in particular to the communication of data via the Internet Protocol (IP).

2. Description of Related Art

Traditionally, communications over the Internet, as well as within other networks, are effected via the use of the Internet Protocol (IP). To transfer a file from a server A to a client B, the client B transmits a request to the server A, using an IP address associated with server A, and provides a return IP address for the server A to use in responding to this request. This return IP address typically refers to a port on client B that is configured to receive incoming data.

A number of schemes exist for illicitly obtaining material from a server. For example, an imposter may intercept requests destined for a particular server, and substitute a different IP address for the return address in the requests. Upon receipt of the data corresponding to the request at the different IP address, the imposter retransmits the data to the original return address, and thus the requestor is unaware of the illicit receipt of the data. In another scheme, the imposter mimics the communications used to grant an authorized user access to a set of data, then proceeds to submit requests to download the data to the imposter's system.

Encryption techniques are available to protect the data that may be intercepted, by preventing the interceptor from deciphering the information content of the data that is intercepted. However, as advances are made in encryption techniques, so are advances made in code-breaking, or key-determining, techniques. With increased computing power being available, and cooperative distributed efforts to crack passwords being common, the security of any transmission cannot be guaranteed.

Most encryption processes are time-consuming and resource-consuming tasks, and may not be practical for the routine transmission of data. That is, not all data is considered sensitive enough to warrant an encryption. At the same time, however, some data lies between “confidential” and “public” and some degree of security would be preferred, albeit not at the expense of encrypting this data.

### BRIEF SUMMARY OF THE INVENTION

It is an object of this invention to provide a security method and apparatus that improves the security of IP data transfers. It is a further object of this invention to provide a security method and apparatus for secure IP data transfers that does not require a data encryption of the data. It is a further object of this invention to provide a security method and apparatus that improves the security of the transfer of encrypted IP data packets.

These objects and others are achieved by providing a system and protocol wherein the IP address for requesting data within a data set is changed during the transfer of the data set. This changing address may include the IP addresses of different ports on a server, or may indicate the IP addresses of different servers. The pattern of changes of the IP address is known to both the client and the server(s), and preferably secret from others. Without knowing the pattern of changes of IP addresses, it will be difficult for an eavesdropper to intercept the data set. To further enhance the security of this approach, the server(s) is configured to expect subsequent requests at the changed IP address. If the subsequent requests do not arrive within a threshold time period, the server(s) is configured to terminate further access to the data set by the requester.

### BRIEF DESCRIPTION OF THE DRAWINGS

The invention is explained in further detail, and by way of example, with reference to the accompanying drawings wherein:

FIG. 1 illustrates an example flow diagram for a client system in accordance with this invention.

FIG. 2 illustrates an example block diagram of a client-server system in accordance with this invention.

FIG. 3 illustrates an example flow diagram for a server system in accordance with this invention.

Throughout the drawings, the same reference numerals indicate similar or corresponding features or functions.

### DETAILED DESCRIPTION OF THE INVENTION

For ease of reference, the term “server system” is used hereinafter to identify one or more servers that are configured to effect data communications to a client in accordance with this invention. Each server has a unique IP address associated with each of one or more ports on the server for receiving IP messages.

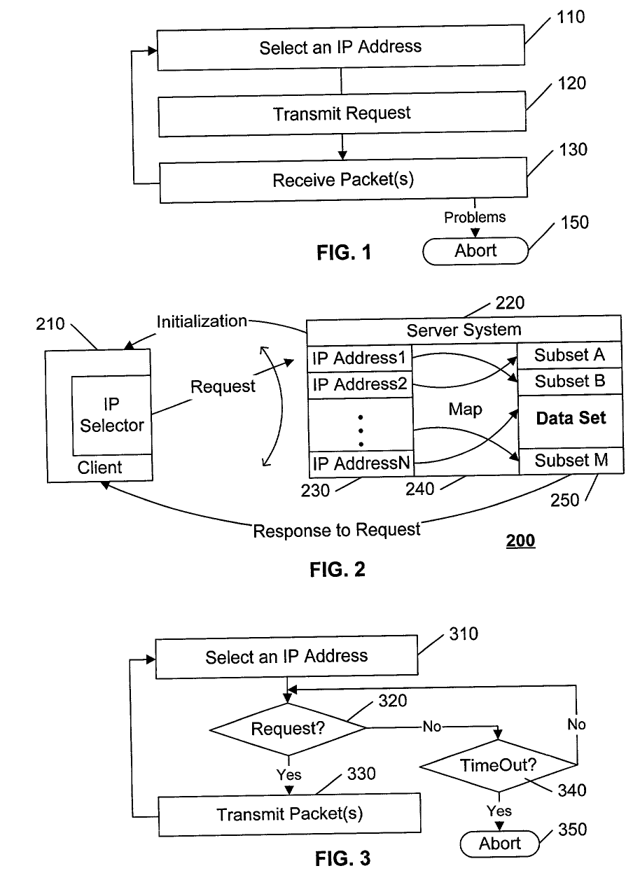

FIG. 1 illustrates an example flow diagram for a client system for accessing a data set in accordance with this invention. At 110, the client selects an IP address for communicating a request for the transmission of data from the server system associated with that IP address. The client sends the request to this IP address, at 120, and receives the data that is communicated from the server system in response to this request, at 130. To receive a complete data set, such as the data corresponding to a web-page, or the data corresponding to an audio/visual recording, multiple requests are sent, typically in a sequential manner, by looping through steps 120-130 until the entire data set is received. If problems occur during the transfer of the information from the server system to the client, the client aborts the process, and typically informs the user of the client of the problem. These steps 120-150 are common in the art.

In accordance with this invention, the client process loops back through the IP address selection block 110 to select either the same IP address, or a different IP address, depending upon a given address-switching algorithm. The address-switching algorithm may include any of a variety of schemes for changing IP addresses, preferably in a pattern that is difficult to deduce, absent a “key” to this algorithm.

In a simple embodiment, the data set may be distributed among a variety of servers, and the key to the algorithm is knowing which IP address to use for each segment or subset of the distributed data set. For data that is required to be accessed in a particular manner, such as a video stream with P, and B frames that are each relative to a prior or subsequent I frame, a distribution of frames among a variety of servers can serve to prevent an unauthorized viewing of the content material, without requiring an encryption of the data set.

In an alternative embodiment, the data set is not physically distributed among the variety of servers, but access to this data set is distributed among the servers. That is, a common server may be configured to only accept requests from a select set of other servers. These other servers are the servers that receive the requests from the client. As each of these other servers receive a request, it forwards the request to the common server, with the return-address of the request to the common server being the client's return address. If an illicit client fails to access the other servers in the proper order, the transmitted data from the common server to this client will be generally incomprehensible.

Variations on the above scheme will be evident to one of ordinary skill in the art in view of this disclosure. For example, the data set may be stored at the common server in a “scrambled” form, wherein a direct download of the data set from the common server would not allow for a meaningful decoding or rendering without a key to the scrambled order of the data within the data set. In this embodiment, the individual servers that receive the client's request contain a mapping between the client's sequentially ordered request for packets from the data set and the corresponding actual location of the packet in the scrambled data set. In this way, the common server receives requests for packets from unordered locations in the data set, and transmits the data to the client in this “unordered” sequence. If the client accesses the individual servers in the proper order, however, this “unordered” sequence corresponds to a descrambling of the scrambled data set, and the client receives the packets in the proper sequence corresponding to the original, unscrambled, data set. This embodiment is particularly well suited for a dynamically changing access sequence, wherein the order of IP addresses can be dynamically changed for each communication session, requiring only a change to the mapping at each server. In a multi-client system, the servers would be configured to contain a mapping corresponding to each current client.

FIG. 2 illustrates an example client-server system 200 in accordance with this invention. The client-server system 200 includes a client 210 that communicates requests to a server system 220. As noted above, the server system 220 is associated with a plurality of IP addresses 230, and may include a plurality of servers, each server having one or more IP addresses. The server system 220 includes a map 240 that associates each subset of a data set 250 with one of the IP addresses 230. The map 240 may be a logical mapping, or a physical mapping. That is, the map may be a sequence list that associates each subset of the data set 250 with an IP address 230, or, the map may correspond to the physical placement of the subsets of the data set 250 at servers corresponding to the IP address 230. In either event, the proper retrieval of the data set 250 requires a proper sequencing of requests from the client 210. In a preferred embodiment of this invention, the server system is configured to communicate initialization information to the client to facilitate a determination of the proper sequence, discussed further below.

As illustrated in this example FIG. 2, IP Address1 is associated with subset B of the data set 250, and IP Address 2 is associated with subset A of the data set 250. If the data is to be retrieved from subset A, followed by subset B, the requests for these subsets must be submitted to IP Address 2, then to IP Address 1. Any other sequence of IP addresses will fail to provide subset A followed by subset B. Note that multiple subsets of data may be associated with a particular IP address. For example, subset C may be also be associated with IP Address 1, and subset D with IP Address 2. In this example, a retrieval of the subsets A-B-C-D, in order, requires a sequence of requests to IP Addresses 2-1-1-2, respectively.

In a more secure embodiment, the server system participates in enforcing the security process, and terminates the communication when the request sequence does not occur in the proper order. FIG. 3 illustrates an example flow diagram for a server system in accordance with this aspect of the invention. In this embodiment, the server system tracks the selection of IP address request, at 310, using an algorithm that corresponds to the algorithm of block 110 in FIG. 1. The server system continuously monitors the input of requests to the selected IP address, at 320. If a request is received, it is processed, and the requested data is transmitted, at 330. If, a 320, a request is not received, the server system determines whether a timeout has occurred, at 340. If the timeout period has not elapsed, the server system continuous to loop, checking for requests, at 320, or a timeout, at 340. If the timeout period has elapsed, the server system aborts subsequent transmission of data from the current data set, at 350. In a preferred embodiment of this aspect of the invention, the server system communicates an enabling message to the particular server corresponding to the selected IP address at 310, and thereafter communicates a disable message to that server. When the server system aborts, at 350, subsequent requests from the client to other IP addresses will be ignored by the server at the selected address, because that server will not have been enabled by server system. Other schemes for terminating the subsequent transmission of data in response to requests after the server system aborts the process will be evident to one of ordinary skill in the art. Note that, in a multi-client system, the enabling and disabling of transmissions in response to requests is performed based on the particular return address associated with the transmission of each data set.

The algorithm used for selecting the sequence of IP addresses may be any algorithm that allows the client system to provide the proper IP address sequence corresponding to the server system's defined IP address sequence for retrieving data from the data set in the proper order. In the example embodiment wherein the data is distributed among a variety of servers, for example, the algorithm must provide the client the proper IP addresses for each subset comprising the data set. Preferably, the client is provided with an ordered list of possible IP addresses for data sets from a particular server system, and the algorithm provides a sequence of indexes to this list corresponding to the sequence of IP addresses. To further enhance the security of the system, the amount of data that is accessed from each indexed IP address also varies, and the algorithm is configured to identify an (index, amount) pair for each access in the sequence. In the above example access to IP addresses 2-1-1-2 to retrieve subsets A-B-C-D, the sequence may be encoded as (2,1)-(1,2)-(2,1), indicating that the second IP address is accessed for one subset, the first IP address is accessed for two subsets, and the second IP address is again accessed for one subset.

In a straightforward embodiment, the sequence may be explicitly communicated to the client, preferably in a secure form, such as an encrypted set of (index, amount) pairs. This encryption can include, for example, an encryption of the sequence using a public key that is associated with the client in a public-key system, wherein knowledge of a corresponding private key is required to decrypt the sequence. Note that the encryption of this set of sequence pairs can be expected to consume substantially less time and resources compared to the encryption of the actual data, and thus a more powerful encryption process may be applied to this encryption, to enhance security.

In another straightforward embodiment, a known algorithm, such as a particular pseudo-random number generator may be used at both the server system and at the client. As is common in the art, given the same “seed” value, a pseudo-random number will generate the same sequence of random numbers. In this embodiment, the server system uses a sequence based on a particular seed value to associate/map each subset within the data set to particular IP addresses. After this association is performed, the server system need only communicate the seed value to the client, preferably in a secure manner. Again, because the encoding of a seed value can be expected to be substantially less time and resource consuming than the encoding of the data set, or the encoding of the actual sequence, stronger encryption techniques can be employed for communicating this seed value.

Alternatively, a secret value that is communicated between the server system and the client during an established security checking procedure may be used to generate the pseudo-random sequence at the server system. If this secret value is known to, or generated by, the client system, there would be no need for the server system to communicate this value to the client. Similarly, existing key exchange algorithms, such as a Diffie-Hillman exchange, can be used to establish a common key at both the client and the server system, and this common key, or a subset or hash of this common key, can be used as the seed value for the pseudo-random number generator at the client and server system.

Also alternatively, conventional secure devices, such as the “SecureNet Key” (SNK) device, that generates a time-dependent pseudo-random “shared secret” that is used by a user to establish communication through a secure firewall, may be used as the basis of the seed value. Because the secret is shared between the user and the server beyond the firewall, it may be directly or indirectly to initiate the random sequence at both the user's (client) system and the server system.

Also alternatively, the communication of the key value may be via an alternative communications means. As is common in the art of banking, for example, a bank often sends a key value, such as a PIN value, to a user via the mail. This key value is then activated if the recipient phones the bank and provides a means of verifying that the recipient is the intended recipient of this PIN. Similarly, the key value may be communicated via a pager system, a fax system, and so on. By communicating the key value using a different communication means than the communication means used to communicate the data, the risk of an interceptor having access to both communications means when this communication is to occur is very low, thereby increasing the inherent reliability of this approach.

Also alternatively, a response to a prior request may include information that is used by the client to determine a subsequent IP address. If, for example, the data is communicated in a secure fashion, a portion of the data may include an index to a next IP address, or may explicitly include the next IP address. In this embodiment, the data itself may be used to identify the IP addressing sequence. For example, a hash value based on the unencrypted first data item in a subset of the data set may be used by the server system to determine the index to the IP address list for the next subset. If the same hash value process is known to the client, and the client is able to decrypt the received subset of the data set, the client can determine the appropriate IP address sequence for requesting the subsets of the data set in the appropriate order. These and other techniques for communicating a key for determining the proper IP addressing sequence will be evident to one of ordinary skill in the art in view of this disclosure.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the server system may be configured to effect additional security processes. In an alternative embodiment the server system is further configured to check for a “mimicking” system that is configured to follow every request from a client with a duplicate request, except with a different IP address for returning the data. Such mimicking systems are effective because most IP communicating systems allow a requester to repeat the request in the event that the transmitted data is not received properly. In a preferred embodiment, if the system receives N sequential requests for a retransmission, the server system terminates the transmission based upon the likelihood of a legitimate user having to repeat each of N transmissions. These and other system configuration and optimization features will be evident to one of ordinary skill in the art in view of this disclosure, and are included within the scope of the following claims.

I claim:

1. A method of providing access to a data set, comprising:
associating each subset of data comprising the data set to a select IP address of a plurality of IP addresses, at least two of the subsets comprising the data set having different select IP addresses of the plurality of IP addresses, and
providing access to each subset of the data set via a request for the subset at the select IP address associated with the subset.

2. The method of claim 1, further including:
communicating information to a client system that facilitates the determination of the select IP address for each subset.

3. The method of claim 2, wherein
the information is communicated to the client system via a secure communication.

4. The method of claim 2, wherein
providing access to each subset occurs via a first communication channel, and
communicating the information to the client system occurs via a second communication channel that differs from the first communication channel.

5. The method of claim 2, wherein
associating each subset to the select IP address is based on a pseudo-random process that is initialized with a seed value, and
the information that is communicated to the client system includes the seed value.

6. The method of claim 2, wherein
the information that is communicated to the client system is encrypted using a public-key system.

7. The method of claim 2, wherein
the information is communicated to the client system within a prior subset of the data set that is communicated to the client system in response to a prior request.

8. The method of claim 1, wherein
providing access to each subset via the request is dependent upon a time duration from a prior request.

9. The method of claim 1, wherein
providing access to each subset via the request is dependent upon a frequency of occurrence of repeated requests for prior subsets of the data set.

10. A method of accessing a data set, comprising:
selecting a first IP address that is associated with a first subset of the data set,
requesting the first subset at the first IP address,
selecting a second IP address that is associated with a second subset of the data set, the second IP address being different from the first IP address, and
requesting the second subset at the second IP address.

11. The method of claim 10, further including
receiving information from a server system, and
wherein
selecting at least one of the first and second IP addresses is based on the information from the server system.

12. The method of claim 11, wherein
the information from the server system facilitates a generation of the first IP address and the second IP address.

13. The method of claim 12, wherein
the information from the server system includes an encrypted seed for a pseudo-random process.

14. A server system comprising:
a plurality of IP addresses, and
a data set that includes a plurality of subsets,
each subset of the plurality of subsets being associated with an IP address of the plurality of IP addresses, and
at least two of the subsets of the plurality of subsets having a different associated IP address of the plurality of IP addresses;
wherein
access to each subset is provided in response to a request for the subset at the associated IP address of the subset.

15. The server system of claim 14, wherein
the server system is further configured to communicate information to a client system to facilitate access to the subsets of the data set in a specific order.

16. The server system of claim 15, wherein
the information is communicated to the client system via a secure communication.

17. The server system of claim 15, wherein
providing access to each subset occurs via a first communication channel, and
the server system communicates the information via a second communication channel that differs from the first communication channel.

18. The server system of claim 15, wherein
the server system is configured to:
associate each subset to its associated IP address based on a pseudo-random process that is initialized with a seed value, and
communicate the seed value to the client system.

19. The server system of claim 15, wherein
the server system is configured to communicate the information to the client system in an encrypted form.

20. The server system of claim 14, wherein
the server system is further configured to provide access to each subset via the request in dependence upon a time duration from a prior request.

21. The server system of claim 14, wherein
the server system is further configured to provide access to each subset via the request in dependence upon a frequency of occurrence of repeated requests for prior subsets of the data set.

22. A client system, comprising
an IP selector that is configured to:
select a first IP address that is associated with a first subset of a data set,
request the first subset from a server system at the first IP address,
select a second IP address that is associated with a second subset of the data set, and
request the second subset from the server system at the second IP address.

23. The client system of claim 22, wherein
the client system is configured to receive information from the server system related to selecting the first IP address and the second IP address.

24. The client system of claim 23, wherein
the information from the server system facilitates a generation of the first IP address and the second IP address.

25. The client system of claim 24, wherein
the information from the server system includes an encrypted seed for a pseudo-random process.
